(19) United States
(12) Patent Application Publication
(10) Pub. No.: US 2004/0103084 A1
(43) Pub. Date: May 27, 2004

(54) Data management system that provides flexible time-based query capability

(75) Inventor: Mark Gregory Megerian, Rochester, MN (US)

Correspondence Address: IBM CORPORATION, ROCHESTER IP LAW DEPT. 917, 3605 HIGHWAY 52 NORTH, ROCHESTER, MN, 55901-7829, US

(73) Assignee: International Business Machines Corporation, Armonk, NY

(21) Appl. No.: 10/301,128

(22) Filed: Nov. 21, 2002

(51) Int. Cl. G06F 17/30

(52) U.S. Cl. 707/3

(57) ABSTRACT

Disclosed is an apparatus, method, and program product for performing time-based queries using an enhanced conventional (called Unitemporal herein) Data Management System (DMS). A user is able to specify a date and time of day as part of a query, and the disclosed DMS will query stored data and return query results that reflect the data as it appeared on the date and at the time specified in the query. The time-based query capability is accomplished by using database journal information to reconstruct the data as of the specified effective time.

### FIELD OF THE INVENTION

The present invention relates to Data Management Systems, and in particular, to time-based queries.

### BACKGROUND OF THE INVENTION

Fundamentally speaking, today's computer systems are primarily used for storage, manipulation, and analysis of information. This information, called data, can be anything from complicated financial information to simple baking recipes. It is no surprise, then, that the overall value, or worth, of a computer system depends largely upon how well the computer system stores, manipulates, and analyzes data. This patent pertains to the mechanism used on a computer system to perform these functions. The phrase Data Management System is used herein to refer to this mechanism, although other terms like “database system,” or just “database,” also apply.

Data Management Systems (DMS), like many other computer programs, come in various “sizes and flavors.” For the purposes of this patent, however, Data Management Systems can be roughly placed into two basic categories: 1) a Conventional (sometimes called Snapshot) DMS, or 2) a Bitemporal DMS. Because it is important in the context of this patent to focus on the temporal characteristics of these two types of data management systems, a conventional DMS is referred to herein as a Unitemporal DMS. As one might guess, a Unitemporal DMS is based upon a single point in time; whereas, a Bitemporal DMS is based upon two points in time.

A Unitemporal DMS is by far the predominant type of database used in the computer industry today. A key drawback to the Unitemporal DMS approach, however, is its limited recognition of time. In the “eyes” of a Unitemporal DMS there is only one time, and that is the current time. Data can be viewed at any given time, but without explicit steps by the user, the data is subject to change as time moves forward. For example, if a user looks at a particular data item on a Monday, that same data item may be changed or even deleted by Tuesday. Now, it is true the data can be preserved by explicitly saving Monday's data (i.e., a “snapshot” of the data can be taken by the user or a Database Administrator). However, someone must know ahead of time that the data (in Monday's form) will/may be needed at a later time. Otherwise, the user is simply out of luck if the user decides Tuesday that he or she wants Monday's data, and the data was somehow altered in the mean time. It should also be noted that it is virtually impossible to predict what the future may bring in terms of what past view of the data may be needed. So, while snapshots are helpful, they represent only a limited solution.

A more comprehensive solution to the problem of time-based queries comes in the form of a Bitemporal DMS. Again, as its name suggests, a Bitemporal DMS is specifically designed to operate with two points of time, the current time, like a conventional DMS, and a user specified time. Thus, the user can specifically request to view data in a past form. The problem with this approach, though, is the overhead associated with storing all of this old data. To accomplish this flexibility, it is necessary for the Bitemporal DMS to store and timestamp old versions of the data. It is true that Bitemporal systems can be tuned to track only certain changes, which reduces overhead to some extent. However, this tuning results in a tradeoff between efficiency and flexibility, which means that time-based queries cannot be performed on every data item. It should also be noted that the optimizations in place to provide for time-based queries amount to overhead regardless of whether a time-based query is actually performed. Said another way, the user is exposed to the performance costs associated with the time-based query capability even if the user is not actually performing a time-based query. Because of these drawbacks, Bitemporal systems have yet to gain widespread acceptance within the general computer industry, and are thus mostly relegated to academic pursuits.

Without a Data Management System that can provide time-based query capability without the overhead associated with Bitemporal Data Management Systems, the industry will continue to be faced with the unpleasant choice between inflexible Unitemporal Data Management Systems and inefficient Bitemporal Data Management Systems.

### SUMMARY OF THE INVENTION

The present invention involves an apparatus, method, and program product for performing time-based queries using a Unitemporal Data Management System. A user is able to specify temporal information as part of a query, and the DMS of the present invention will query stored data and return the results of the query. The returned results are time-specific in that they represent the results that would have been obtained had the query been performed at the time specified in the supplied temporal information.

The DMS of the preferred embodiment of the present invention performs time-based queries by using database journal information to reconstruct the data so that the results are time-specific according to the supplied temporal information.

Certain terms and phrases are defined as follows.

| Term/Phrase | Definition |
|---|---|
| Unitemporal Data Management | A Unitemporal DMS is one that when |
| System | queried considers only the current time. |
| Time-Specific Representation | A representation of data values and/or |
| | meta data at a specified time. |
| Past Time-Specific | A representation of data values and/or |
| Representation | meta data at a specified time in the past. |
| Current Time-Specific | A current representation of data values |
| Representation | and/or meta data. |
| Temporal Information | Information that can be used to specify |
| | time, time of day or a date for example. |
| Time-Based Query | A query that specifies temporal |
| | information for use in generating a |
| | time-specific representation. |

### BRIEF DESCRIPTION OF THE DRAWINGS

FIG. 1 is a block diagram showing the computer system used in the preferred embodiment of the present invention.

FIG. 2 is a block diagram showing the Data Management Systems used in the preferred embodiment of the present invention.

FIG. 3 is a flow diagram showing the steps used to carry out highlighted processing of the Language Parser of the preferred embodiment.

FIGS. 4A and 4B are flow diagrams showing the steps used to carry out highlighted processing of the Database Engine of the preferred embodiment.

FIG. 5 is a flow diagram showing the steps used to carry out highlighted processing of the Query Engine of the preferred embodiment.

FIGS. 6A-6C show example tables used herein to explain the preferred embodiment of the present invention.

FIG. 7 is an example journal used herein to explain the preferred embodiment of the present invention.

### DESCRIPTION OF THE PREFERRED EMBODIMENT

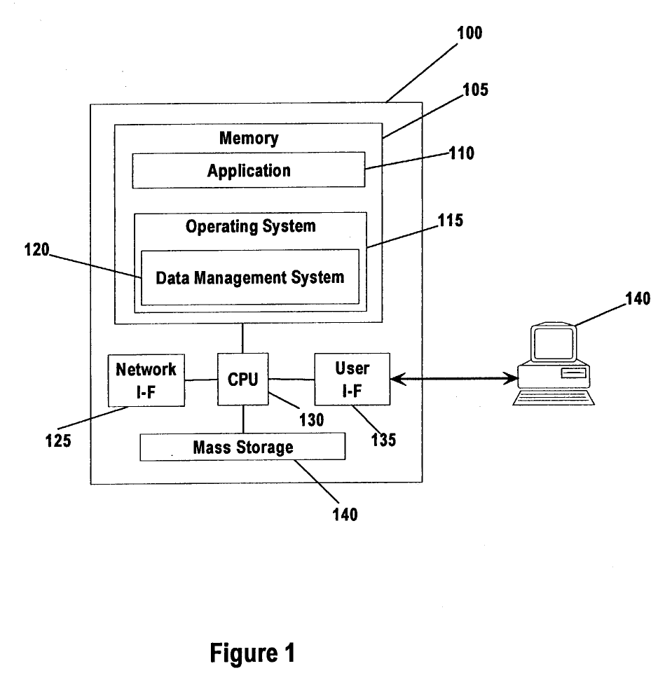

Turning now to the drawings, FIG. 1A shows some of the operational components used in the computer system of the preferred embodiment of the present invention. Computer system 100 is an enhanced IBM iSeries computer system, although other computer systems could be used. Depicted components include central processing unit (CPU) 130, network interface 125, user interface 135, mass storage 140, and memory 105. CPU 130 is used to execute the programs stored in memory 105, although it should be understood that at certain times these programs may partially or completely reside in mass storage 140. Network interface 125 is used to communicate with other computer systems. User interface 135 is used to accept commands and relay information to the one or more users of computer system 100.

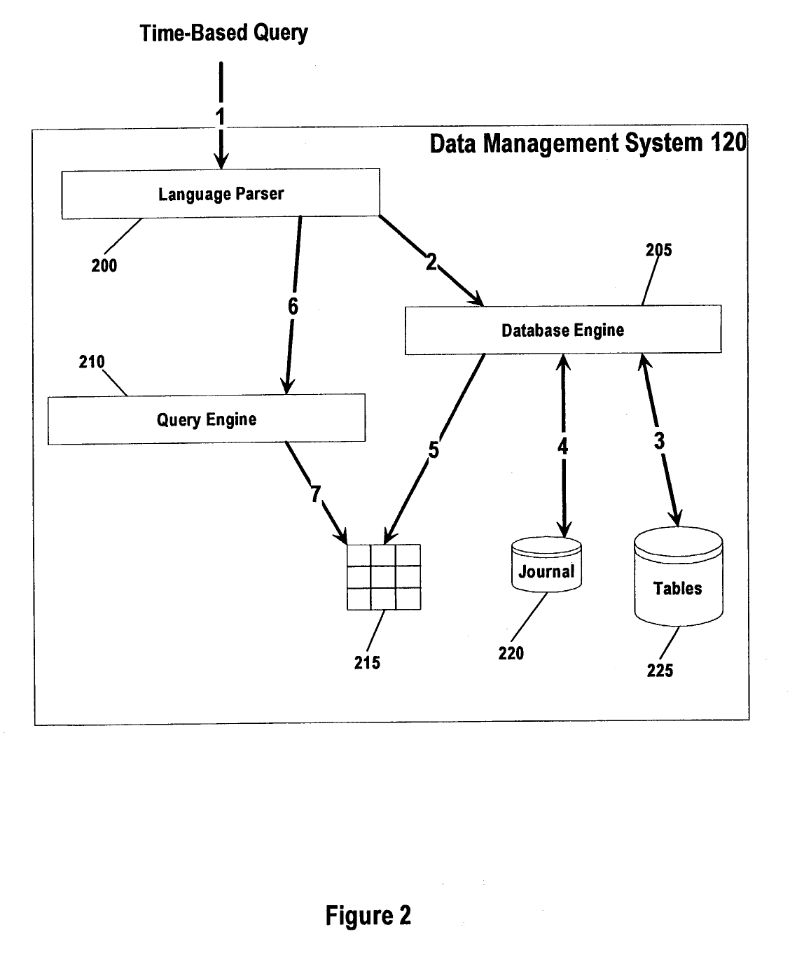

Operating system 115 contains Data Management System (DMS) 120. DMS 120, which is described in forthcoming paragraphs and with reference to FIGS. 2-7, is integrated into operating system 115, although non-integrated operating systems could be used in the alternative. Application 110 is an example application program that may be used to access data controlled by DMS 120.

As a preliminary matter, it should be understood that while the embodiments of the present invention are being described herein in the context of a complete system, certain program mechanisms, such as DMS 120, are capable of being distributed in program product form. Of course, a program product can be distributed using different types of signal bearing media, including, but not limited to: recordable-type media such as floppy disks and CD ROMs; and transmission-type media such as digital and analog communications links.

FIG. 2 is a block diagram showing some of the internal components of DMS 120 of the preferred embodiment. Each of these components is described in more detail in the forthcoming paragraphs. However, as an overview, Language Parser 200 is responsible for interpreting queries and determining whether a time-based query has been requested. Database Engine 205 uses Tables 225 and Journal 220 to generate Temporary Table 215. Query Engine 210 uses Temporary Table 215 to generate time-specific query results for the time-based query.

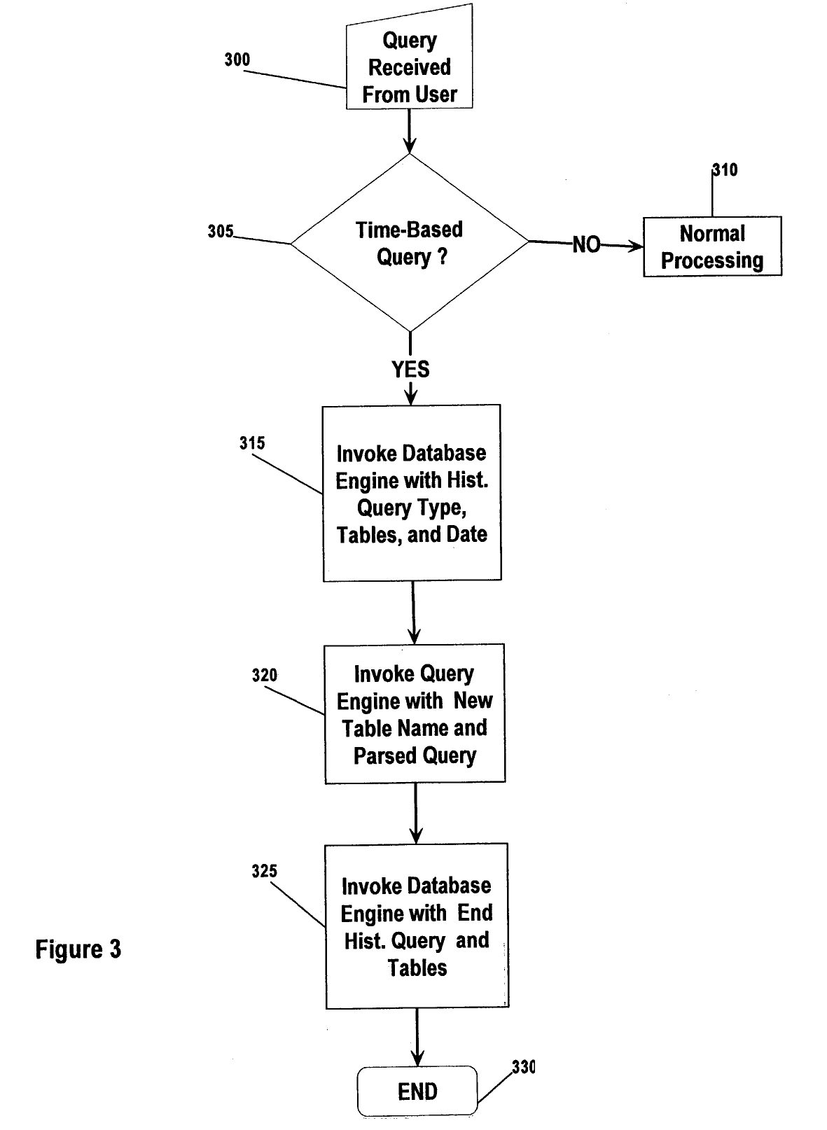

FIG. 3 is a flow diagram showing the steps used to carry out highlighted processing of Language Parser 200. As its name suggests, Language Parser 200 is responsible breaking queries down into known pieces. Different actions are then taken based upon what pieces are identified. As shown, Language Parser 200 receives a query in block 300. Language Parser 200 first determines whether the query is a time-based query [block 305]. In the preferred embodiment, a time-based query is identified through use of the HISTORICAL key word, followed by sub-key words DATE and TIME. Thus, in the preferred embodiment, date and time of day are used as temporal information. However, other ways of specifying time could be used. For example, just date, or just time of day could be used; or a running time (e.g., in seconds) from a known start time could be used.

Returning to block 305 of FIG. 3, if the query is not a time-based query, Language Processor 200 continues with its normal processing. Since this processing is not important vis-à-vis the preferred embodiment, its details are not provided here. When Language Parser 200 identifies a time-based query, it also parses out the name of the table(s) that is the subject of the query and the date and time of day specified in the query (referred to herein as the effective time). Language Processor 200 then invokes Database Engine 205 with the database table and the effective time [block 315].

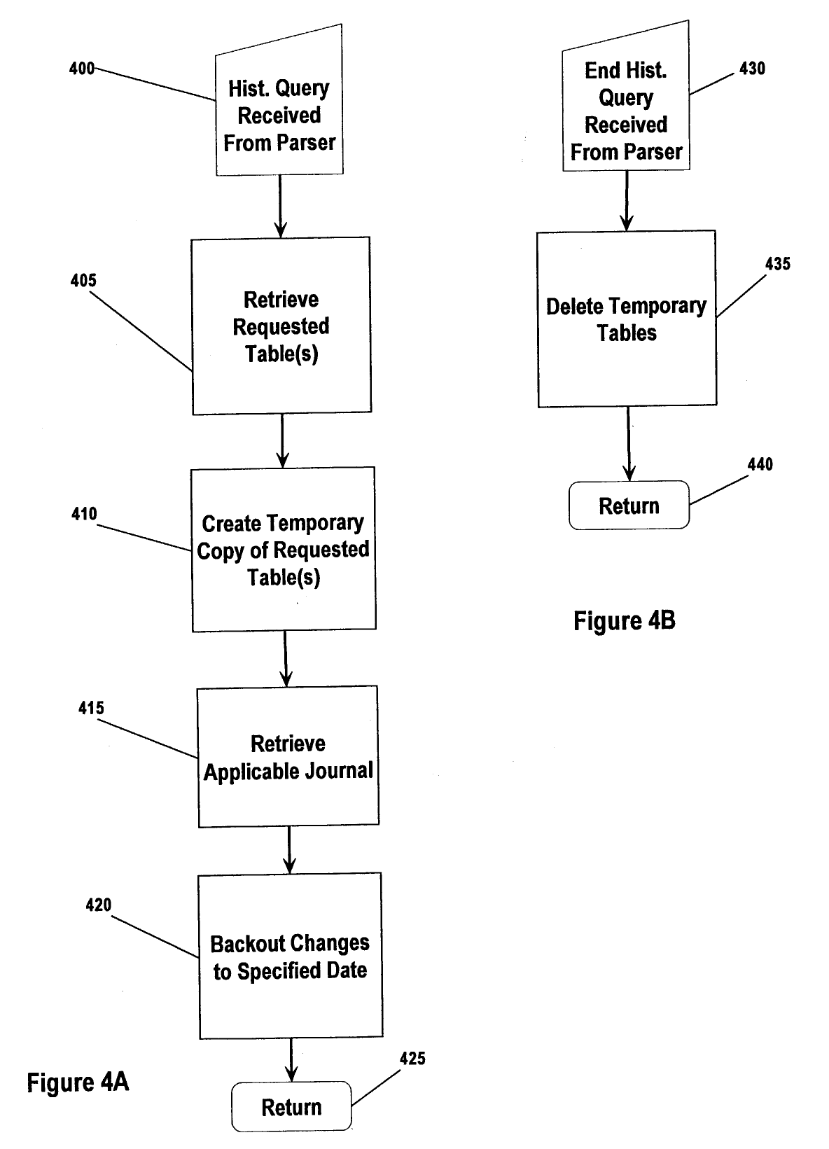

FIG. 4A is a flow diagram showing the steps used to carry out highlighted processing of Database Engine 205. Database Engine 205, recognizing the time-based query, first retrieves the current version of the table(s) specified in the query [block 405]. Database Engine 205 then makes a temporary copy of the retrieved table [block 410].

After making a temporary copy of the retrieved table, Database Engine 205 retrieves the journal associated with the specified table. In the iSeries database implementation, journals are organized based upon libraries. A library is a higher-level construct that includes one or more tables. The journal (shown here as Journal 220), which is a common construct in the database industry, is essentially a computer system file used to store changes to the database. As such, Journal 220 can be thought of as a record of additions, updates, and deletions to the information (see Tables 225) contained in the database. A journal is conventionally used for transaction processing and to adjust (i.e., rollback or rollforward) the entire database to a specified date because of a catastrophic failure. In the transaction processing sense, a journal is thus used as a trail of changes that can be reversed if all of the changes required by a given transaction do not occur successfully. In the catastrophic failure sense, a journal is used to bring an old copy of a database up to date (as much as possible) when the current copy is lost or to return the data to a known, prior state if the most recent copy of the data has become unreliable for some reason.

It should be noted, however, that Database Engine 205 of the preferred embodiment does not use Journal 220 in a conventional manner. Unlike existing journal uses, Database Engine 205 uses Journal 220 to: 1) identify changes to the specified table that were made between the effective time and the current time and then 2) to reverse the identified changes [block 420]. For example, assume that the current date is Nov. 11, 2002 and the effective date (as specified in the time-based query) is Jul. 8, 2001. Assume also that a change was made to the specified table on Jul. 5, 2001 and again on Jul. 17, 2001. Database Engine 205 would identify the change made on July 17 as having occurred between the effective date and the current date, but the July 5 change would not be similarly identified. Thus, of these two changes, only the July 17 change would be reversed in Temporary Table 215.

After Temporary Table 215 has been completely reversed back to its effective date state [block 420], it amounts to a time-specific representation of the data (i.e., data values and/or meta data) stored therein. In this case, Temporary Table 215 is a past time-specific representation of the data stored therein. Database Engine 205 returns control to Language Parser 200 [block 425]. Language Parser 200 strips the HISTORICAL keyword and DATE and TIME sub-keywords from the time-based query and invokes Query Engine 210 with the query and Temporary Table 215 [see block 320 of FIG. 3].

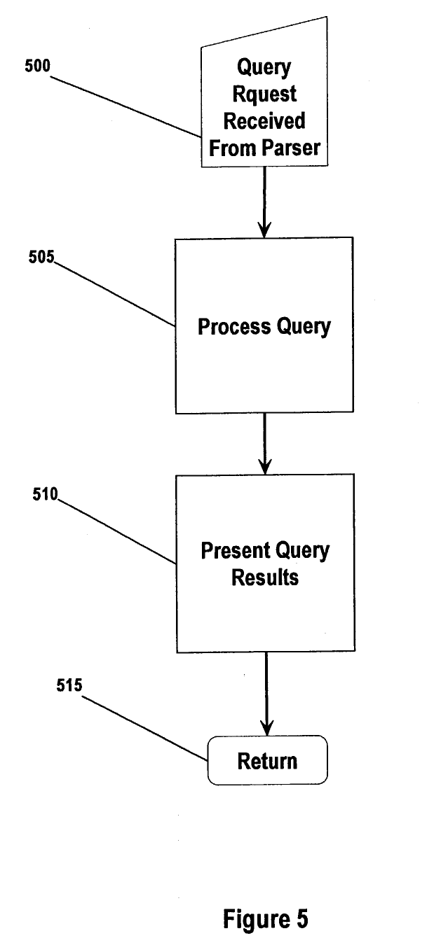

FIG. 5 is a flow diagram showing the steps used to carry out highlighted processing of Query Engine 210 of the preferred embodiment. Query Engine 210 receives the query in block 500 and proceeds to execute the query using temporary table 215. Note here that Query Engine 210 does not need to be specifically adapted to operate within the preferred embodiment. The fact that the specified query is a time-based query is hidden from Query Engine 210 so that Query Engine 210 can process the specified query on the specified table (here Temporary Table 215) as it would any other query. After the query has been processed, Query Engine 210 presents the results to the user [block 510] and returns control to Language Processor 220 [block 515]. Note here that the results presented to the user are a past time-specific representation of at least some of the data values stored within Temporary Table 215. The results, though, may also include a past time-specific representation of meta data stored within Temporary Table 215. For example, one or more columns present in a past time specific representation may not be present in a current time-specific representation, and vice versa.

Language Processor 220 regains control in block 325 of FIG. 3. Language Processor 220 then again invokes Database Engine 205 with an end of time-based query notification (END_Hist) and the table or tables at issue. Database Engine 205 receives this notification in block 430 of FIG. 4B. Database Engine 205 then proceeds to deletes the specified table or tables [block 435] and return control to Language Parser 22 in block 440. Language Parser 200 then terminates execution in block 330 of FIG. 3.

### PROCESSING EXAMPLE

The following example is used to provide additional insight into the inner workings of the preferred embodiment and into the benefits and advantages of the present invention. Consider a hypothetical hockey player named Scott Stanley. Scott is an excellent young prospect. In fact, after a promising year in the Quebec Major-Junior league, Scott was drafted third overall in this year's entry draft by his hometown team, the Worchester Wolves. Scott knows, though, that he will need serious help if he is to successfully navigate the negotiations and other intricacies associated with his first professional contract.

Even though Scott considers himself naive when it comes to understanding all that goes into a big league contract, he does know that he really wants to be a pro hockey player. Therefore, while he certainly wants to be treated fairly, he definitely does not want to be involved in a contract dispute, or worse, a contact hold-out. Therefore, Scott decides that he needs an agent who can get him on the ice at the start of training camp after having signed a fair agreement.

With this philosophy in mind, Scott begins his quest for an agent. Unfortunately, Scott's potential has made him a target for each and every pro agent out there. As one might also expect, Scott is having difficulty determining which agents really agree with Scott's philosophy and which agents are just acting the part in an effort to get Scott's business. Scott is having trouble deciding which way to go, when he receives a call from Ted Jones, an agent Scott interviewed just that morning. Ted tells Scott that he understands Scott's dilemma, and that he (Ted) has prepared a report which will help Scott better understand Ted's track record.

Ted hoped that such a report would convince Scott that Ted was being forthright when espousing the same signing philosophy as Scott. Since Ted didn't know (back in 2000 and 2001) that he would be needing the report, he hadn't saved off copies of his client database for each of those years; and besides, hockey contracts are signed at different times during the Spring and Summer, so it would have been impossible for Ted to guess when to take the snap shots anyway. However, Ted had remembered that his DMS has time-based query capability.

When Ted sat down to create his report, he decided that his first page should show where he started (i.e., with his first two clients). Ted issued his first query to produce an older view of his client database. The time-based query used in the preferred embodiment follows an enhanced version of the iSeries Database Query Language. Ted used the following query.

| | |
|---|---|
| OPNQRYF | FILE((CLIENTS)) |
| | KEYFLD((PlayerName *ASCEND)) |
| | MAPFLD(PlayerName PlayerTeam Goals Assists PenMins |
| | Salary) |
| | HISTORICAL(‘04/25/2000’ ‘01:01:01’) |

However, it should be understood that enhancements to other query languages would be equally effective. Consider, for example, use of the HISTORICAL key word in the well-known Standard Query Language (SQL) format. See the alternative SQL query below.

SELECT Player Name, Player Team, Goals, Assists, Penalty Mins., Salary

FROM Clients

HISTORICAL DATE=‘Apr. 25, 2000’ AND TIME=‘01:01:01’

ORDER BY Player Name

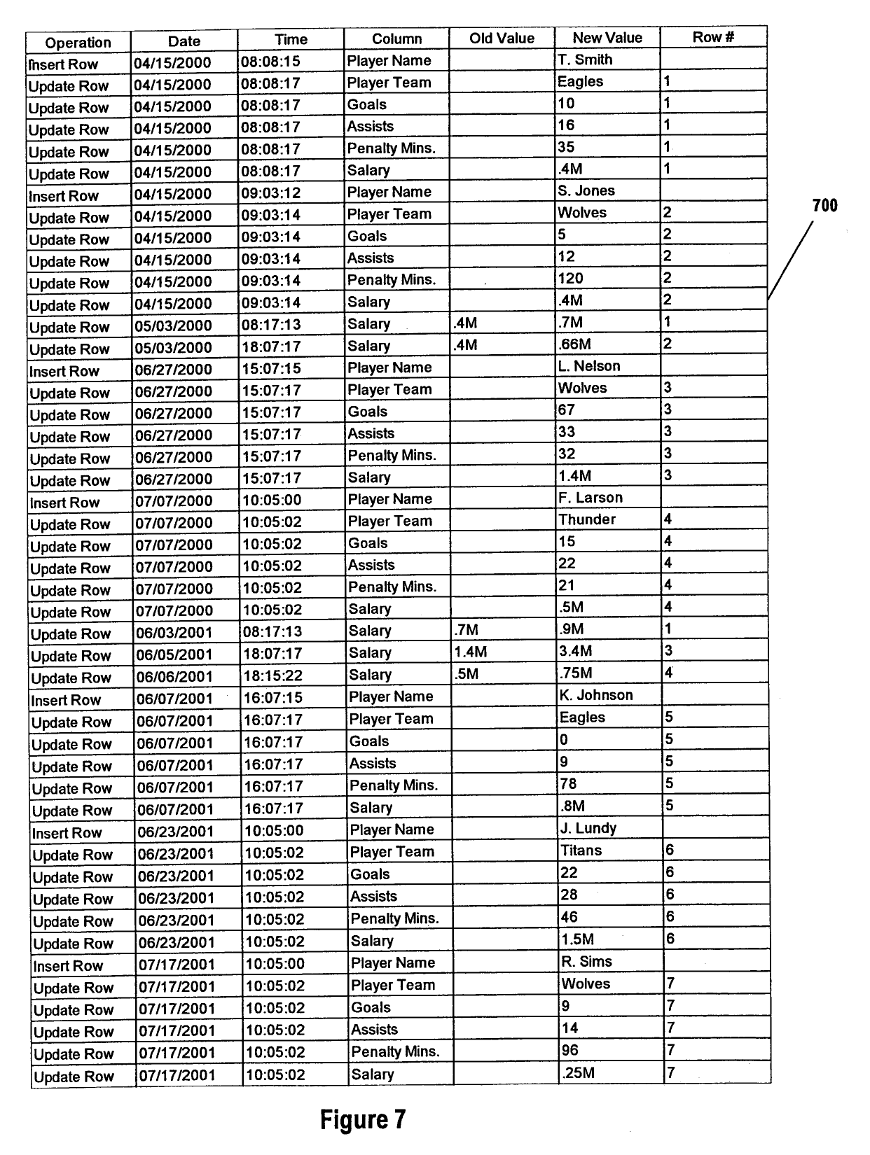

When Language Parser 200 receives Ted's query, the query is immediately recognized as a time-based query through the presence of the HISTORICAL key word. Language Processor 220 then invokes Database Engine 205, passing it 1) notification of a time-based query, 2) the name of the table to be queried (“Clients” in this case), and 3) the effective date and time of day specified in the query (‘Apr. 25, 2000’ and ‘01:01:01’). Database Engine 205 responds by first retrieving the “Clients” table and then making a copy of it. The “Clients” table, as initially retrieved by Database Engine 205, will contain the most up to date data. Database Engine 205 will then retrieve the journal associated with the “Clients” table. The journal (Journal 700) is shown in FIG. 7. (As mentioned earlier, database journals are used for differing purposes. For clarity, only those journal entries which bear on this explanation are shown in Journal 700 of FIG. 7.)

After making a copy of the “Clients” table, Database Engine 205 uses Journal 700 to bring the “Clients” table back to the state it was in on Apr. 25, 2000. Database Engine 205 first determines that rows 3-7 were created after Apr. 25, 2000 (see Insert Row operations on Jun. 27, 2000, Jul. 07, 2000, Jun. 07, 2001, Jun. 23, 2001, and Jul. 17, 2001). These rows are then deleted from the “Clients” table, leaving only rows 1 and 2. Database Engine 205 then determines that the salary column of row 1 was changed from 0.7M to 0.9M on Jun. 3, 2001. Database Engine 205 replaces the newer value (0.9M) with the older value (0.7M). Database Engine 205 also determines that the salary column of row 2 was changed from 0.4M to 0.66M on May 03, 2001. Database Engine 205 replaces the newer value (0.66M) with the older value (0.4M). Database Engine 205 also determines that the salary column of row 1 was changed from 0.4M to 0.7M on May 03, 2001. Database Engine 205 replaces the newer value (0.7M) with the older value (0.4M). Control is returned to Language Processor 200, which in turn strips off the time-based query keywords from Ted's query and invokes Query Engine 210, passing it the copy of the “Clients” table. Query Engine 210 executes the remaining pieces of Ted's query against the copy of the “Clients” table. The results, which are a past (Apr. 25, 2000) time-specific representation of Ted's client database, are then presented to Ted.

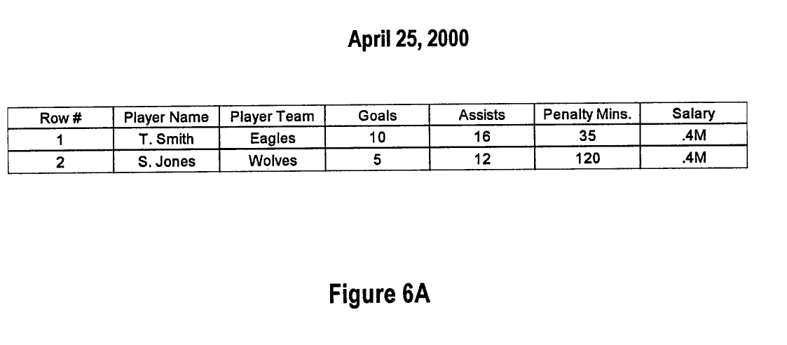

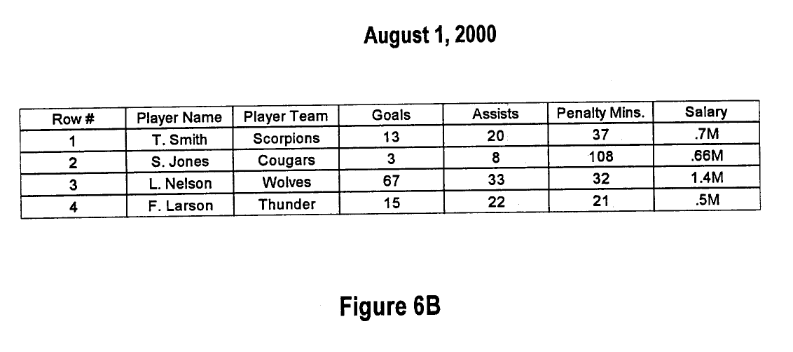

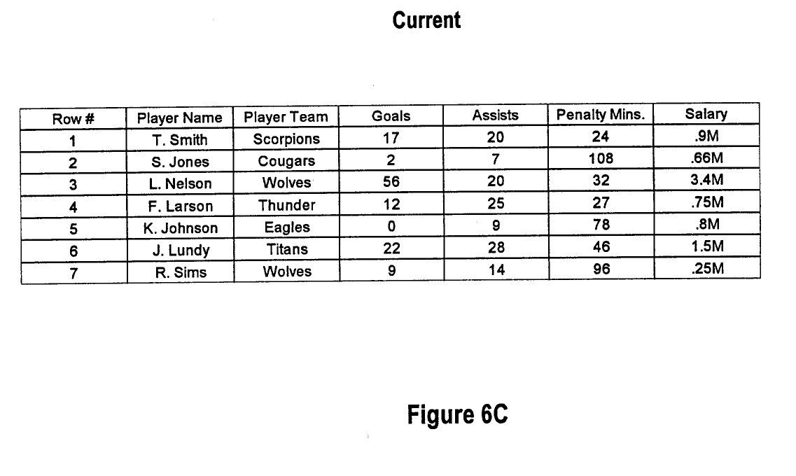

As mentioned, Ted used these results as the first page of his report for Scott. Ted includes the title “Apr. 25, 2000 (see FIG. 6A). As shown, Ted started out in 2000 with two clients, Steve Jones, Ted's brother, and Steve's good friend, Tom Smith. Steve, who played for the Eagles at the time, was earning 0.4M per year, while Tom, who played for the Wolves was also earning 0.4M per year. Both players' teams had not made the playoffs that year, and both wanting a fresh start, decided to give Ted a try.

Knowing that he had a good Summer in 2000, Ted decided to have the next page show the database view from Aug. 1, 2000 as his next page. Ted used the following query.

| | |
|---|---|
| OPNQRYF | FILE((CLIENTS)) |
| | KEYFLD((PlayerName *ASCEND)) |
| | MAPFLD(PlayerName PlayerTeam Goals Assists PenMins |
| | Salary) |
| | HISTORICAL(‘08/01/2000’ ‘01:01:01’) |

An alternative SQL query would be.

SELECT Player Name, Player Team, Goals, Assists, Penalty Mins., Salary

FROM Clients

HISTORICAL DATE=‘Aug. 01, 2000’ AND TIME=‘01:01:01’

ORDER BY Player Name

Language Parser 200 will again immediately recognize Ted's query as a timebased query. Database Engine 205 is again invoked with the required information (e.g., specified table, date, time of day, etc.). After copying the “Clients” table, Journal 700 is used to bring the “Clients” table back to its state at the effective time, in this instance as of Aug. 01, 2001.

When analyzing Journal 700, Database Engine 205 first determines that rows 5-7 were created after Aug. 01, 2000 (see Insert Row operations on Jun. 07, 2001, Jun. 23, 2001, and Jul. 17, 2001). These rows are then deleted from the “Clients” table, leaving rows 1-4. Database Engine 205 then determines that the salary columns for several rows have changed since Aug. 01, 2000, row 4 from 0.5M to 0.75M on Jun. 06, 2001, row 3 from 1.4M to 3.4M on Jun. 05, 2001, and row 1 from 0.7M to 0.9M on Jun. 03, 2001. Database Engine 205 backs out these changes by replacing the new values with the older values. Database Engine 205 then returns control to Language Processor 200, which strips off the time-based query keywords from Ted's query and then invokes Query Engine 210, passing it the copy of the “Clients” table. Query Engine 210 executes the remaining pieces of Ted's query against the copy of the “Clients” table. The results, which are a past (Aug. 01, 2000) time-specific representation of Ted's client database, are then presented to Ted.

As mentioned, Ted used these results as the second page of his report for Scott. Ted includes the title Aug. 1, 2000 (see FIG. 6B). As shown, both of his first clients were traded to new teams. Steve Jones, Ted's brother, was traded from the Wolves to the Cougars, where Ted was able to negotiate a new, incentive laden contract worth up to 0.66M. Tom Smith was traded from the Eagles to the Scorpions, where Ted was able to negotiate a new contract worth 0.7M. Because of his success with Steve and Tom, Ted was also able to pick up two new clients, Fred Larson of the Thunder and Larry Nelson, the highly touted young center from the Wolves.

For the last page of his report, Ted decided to generate a current view of his Clients database. To do so, he submits the following standard query.

| | |
|---|---|
| OPNQRYF | FILE((CLIENTS)) |
| | KEYFLD((PlayerName *ASCEND)) |
| | MAPFLD(PlayerName PlayerTeam Goals Assists PenMins |
| | Salary) |

An alternative SQL query would be.

SELECT Player Name, Player Team, Goals, Assists, Penalty Mins., Salary

FROM Clients

ORDER BY Player Name

DMS 120 receives this last query and processes it in the standard way. The results, which are a current time-specific representation of Ted's client database, are then presented to Ted. Ted's last page (see FIG. 6C) shows that he has built his representation up to seven players, with the addition of Johnson, Lundy, and Sims. The final page, when shown in the context of the other pages, also shows that Ted negotiated a huge raise for Nelson, from 1.4M to 3.4M, and a nice raise for Larson, from 0.5M to 0.75M.

When Scott reviews Ted's report, he notices that Ted has grown his representation substantially in the last two years, which Scott takes to be a good sign. Scott also notices the nice raises Ted has negotiated over the years, but most importantly, Scott sees that Ted already represents two other Wolves players (Nelson and Sims). Scott is convinced, and agrees to representation by Ted.

Ted, thankful for the time-based query capability of his DMS, adds Scott's information to his Client database. Ted didn't have the foresight to save off the data at different intervals of time and had no idea that the snapshots of data taken on these particular dates would be of any value. But the time-based query capability of his DMS allowed him to generate these reports without having had the prior knowledge of which dates would be useful in the future.

The embodiments and examples set forth herein were presented in order to best explain the present invention and its practical application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A method for performing a time-based query, said method comprising the steps of:
receiving said time-based query, said time-based query comprising temporal information;
applying said time-based query to data stored in a Unitemporal database; and
returning results based on said time-based query, said results being a time-specific representation of said data relative to said temporal information.

2. The method of claim 1 wherein said temporal information comprises a time.

3. The method of claim 1 wherein said temporal information comprises a date.

4. The method of claim 1 wherein said applying step further comprising the substep of:
using a journal to create said time-specific representation of said data prior to said applying step.

5. The method of claim 4 wherein said using step comprises the steps of:
copying said data to create copied data; and
using said journal to reverse changes to said copied data that occurred between and effective time and a current time, said effective time being specified in said temporal information.

6. A method for performing a time-based query, said method comprising the steps of:
receiving said time-based query, said time-based query comprising temporal information;
using a database journal to convert data stored in a database in a current time-specific representation into a past time-specific representation, an effective time of said past time-specific representation being specified in said temporal information; and
applying said time-based query against said past time-specific representation; and
presenting results of said applying step.

7. The method of claim 6 wherein said temporal information comprises a time.

8. The method of claim 6 wherein said temporal information comprises a date.

9. A method for performing a time-based query, said method comprising the steps of:
receiving said time-based query, said time-based query comprising temporal information;
converting data stored in a database in a current time-specific representation into a past time-specific representation, an effective time of said past time-specific representation being specified in said temporal information; and
presenting results, said results being based upon said past time-specific representation.

10. The method of claim 9 wherein said temporal information comprises a time.

11. The method of claim 9 wherein said temporal information comprises a date.

12. A program product, said program product comprising:
signal bearing media; and
a program disposed on said signal bearing media, said program being configured to perform the steps of,
receiving said time-based query, said time-based query comprising temporal information;
applying said time-based query to data stored in a Unitemporal database; and
returning results based on said time-based query, said results being a time-specific representation of said data relative to said temporal information.

13. The program product of claim 12 wherein said temporal information comprises a time.

14. The program product of claim 12 wherein said temporal information comprises a date.

15. The program product of claim 12 wherein said applying step further comprising the substep of:
using a journal to create said time-specific representation of said data prior to said applying step.

16. The program product of claim 15 wherein said using step comprises the steps of:
copying said data to create copied data; and
using said journal to reverse changes to said copied data that occurred between and effective time and a current time, said effective time being specified in said temporal information.

17. A program product for performing a time-based query, said program product comprising:
signal bearing media; and
a program disposed on said signal bearing media, said program being configured to perform the steps of,
receiving said time-based query, said time-based query comprising temporal information;
using a database journal to convert data stored in a database in a current time-specific representation into a past time-specific representation, an effective time of said past time-specific representation being specified in said temporal information; and
applying said time-based query against said past time-specific representation; and
presenting results of said applying step.

18. The program product of claim 17 wherein said temporal information comprises a time.

19. The program product of claim 17 wherein said temporal information comprises a date.

20. A program product for performing a time-based query, said program product comprising:
signal bearing media; and
a program disposed on said signal bearing media, said program being configured to perform the steps of,
receiving said time-based query, said time-based query comprising temporal information;
converting data stored in a database in a current time-specific representation into a past time-specific representation, an effective time of said past time-specific representation being specified in said temporal information; and
presenting results, said results being based upon said past time-specific representation.

21. The program product of claim 20 wherein said temporal information comprises a time.

22. The program product of claim 20 wherein said temporal information comprises a date.

23. An apparatus, said apparatus comprising:
a processor;
memory; and
a program stored in said memory for execution on said processor, said program being configured to perform the steps of,
receiving said time-based query, said time-based query comprising temporal information;
applying said time-based query to data stored in a Unitemporal database; and
returning results based on said time-based query, said results being a time-specific representation of said data relative to said temporal information.

24. The apparatus of claim 23 wherein said temporal information comprises a time.

25. The apparatus of claim 23 wherein said temporal information comprises a date.

26. The apparatus of claim 23 wherein said applying step further comprising the substep of:
using a journal to create said time-specific representation of said data prior to said applying step.

27. The apparatus of claim 26 wherein said using step comprises the steps of:
copying said data to create copied data; and
using said journal to reverse changes to said copied data that occurred between and effective time and a current time, said effective time being specified in said temporal information.

28. An apparatus for performing a time-based query, said program product comprising:
a processor;
memory; and
a program stored in said memory for execution on said processor, said program being configured to perform the steps of,
receiving said time-based query, said time-based query comprising temporal information;
using a database journal to convert data stored in a database in a current time-specific representation into a past time-specific representation, an effective time of said past time-specific representation being specified in said temporal information; and
applying said time-based query against said past time-specific representation; and
presenting results of said applying step.

29. The apparatus of claim 28 wherein said temporal information comprises a time.

30. The apparatus of claim 28 wherein said temporal information comprises a date.

31. An apparatus for performing a time-based query, said program product comprising:
a processor;
memory; and
a program stored in said memory for execution on said processor, said program being configured to perform the steps of,
receiving said time-based query, said time-based query comprising temporal information;
converting data stored in a database in a current time-specific representation into a past time-specific representation, an effective time of said past time-specific representation being specified in said temporal information; and
presenting results, said results being based upon said past time-specific representation.

32. The apparatus of claim 31 wherein said temporal information comprises a time.

33. The apparatus of claim 31 wherein said temporal information comprises a date.
